(19) United States
(12) Patent Application Publication
(10) Pub. No.: US 2020/0355806 A1
(43) Pub. Date: Nov. 12, 2020

(54) ELECTRONIC APPARATUS AND DISTANCE MEASURING METHOD

(71) Applicant: KABUSHIKI KAISHA TOSHIBA, Minato-ku (JP)

(72) Inventors: Kentaro YOSHIOKA, Kawasaki (JP); Tuan Thanh TA, Kawasaki (JP); Hidenori Okuni, Yokohama (JP)

(73) Assignee: KABUSHIKI KAISHA TOSHIBA, Minato-ku (JP)

(21) Appl. No.: 16/817,678

(22) Filed: Mar. 13, 2020

(30) Foreign Application Priority Data
May 10, 2019 (JP) 2019-090052

(51) Int. Cl. G01S 7/4865; G01S 7/487

(52) U.S. Cl. CPC G01S 7/4865; G01S 7/4873

(57) ABSTRACT

An electronic apparatus has a light receiver configured to receive a reception light including a reflected pulse provided by a reflection of an emitted pulse on an object, wherein the reception light is received during at least a first time and a second time, and the second time is earlier than the first time, a memory configured to store a digital signal representing a part of information on the reception light received during the second time, and processing circuitry configured to measure a distance to the object based on a difference between emission timing of the emitted pulse and reception timing of the reflected pulse by using the information on the reception light received during the first time and the part of information on the reception light received during the second time.

### CROSS REFERENCE TO RELATED APPLICATIONS

This application is based upon and claims the benefit of priority from the prior Japanese Patent Application No. 2019-090052, filed on May 10, 2019, the entire contents of which are incorporated herein by reference.

### FIELD

Embodiments described herein relate generally to an electronic apparatus and a distance measuring method.

### BACKGROUND

A technique to measure the distance to an object is known, in which a laser beam is emitted to the object and the distance to the object is measured based on emission timing at which the laser beam is emitted and reception timing at which a reflected laser beam from the object is received. This technique has been attracting attention as being indispensable for collision prevention or automatic driving of vehicles since the use of such a technique enables a high-speed and contactless detection of a distance to an obstacle around a vehicle.

A reflected laser beam from the object is received together with ambient light such as sunlight. It is therefore difficult to distinguish the reflected laser beam from the ambient light if the light intensity of the reflected laser beam is weak. In order to accurately distinguish the reflected laser beam from the ambient light, it may be necessary to convert the reception signal to a digital signal, store the digital signal in a memory, and perform signal processing such as averaging on the digital signal. In recent years, there has been a demand to increase the distance to objects that can be measured. In order to meet the demand, a large amount of pixel data corresponding to the received light should be stored. This requires a large capacity memory, which leads to an increase in facility costs. In particular, when the above-described distance measuring function is intended to be achieved by a system on chip (SoC) module, an increase in capacity of memory may make it difficult to form a chip.

### BRIEF DESCRIPTION OF THE DRAWINGS

FIG. 1 is a block diagram illustrating a schematic configuration of an electronic apparatus according to a first embodiment.

FIG. 2A is a diagram illustrating an example in which the light intensity of a second light is temporarily greater than a first reference level.

FIG. 2B is a diagram showing that the light intensity of the second light is not greater than the first reference level.

FIG. 3 is a flowchart of an operation of the electronic apparatus according to the first embodiment.

FIG. 4 is a schematic diagram illustrating a signal waveform of a reception signal of a SiPM.

FIG. 5 is a block diagram illustrating a schematic configuration of an electronic apparatus according to a third embodiment.

FIG. 6 is a schematic diagram illustrating the operation of a time sharing detector.

### DETAILED DESCRIPTION

An electronic apparatus has a light receiver configured to receive a reception light including a reflected pulse provided by a reflection of an emitted pulse on an object, wherein the reception light is received during at least a first time and a second time, and the second time is earlier than the first time;

a memory configured to store a digital signal representing a part of information on the reception light received during the second time; and

processing circuitry configured to measure a distance to the object based on a difference between emission timing of the emitted pulse and reception timing of the reflected pulse by using the information on the reception light received during the first time and the part of information on the reception light received during the second time.

Embodiments of an electronic apparatus and a distance measuring method will now be described with reference to the accompanying drawings. Although most of the following descriptions are for the main part of the electronic apparatus, other parts or functions that are not illustrated or explained may be included in the electronic apparatus.

### First Embodiment

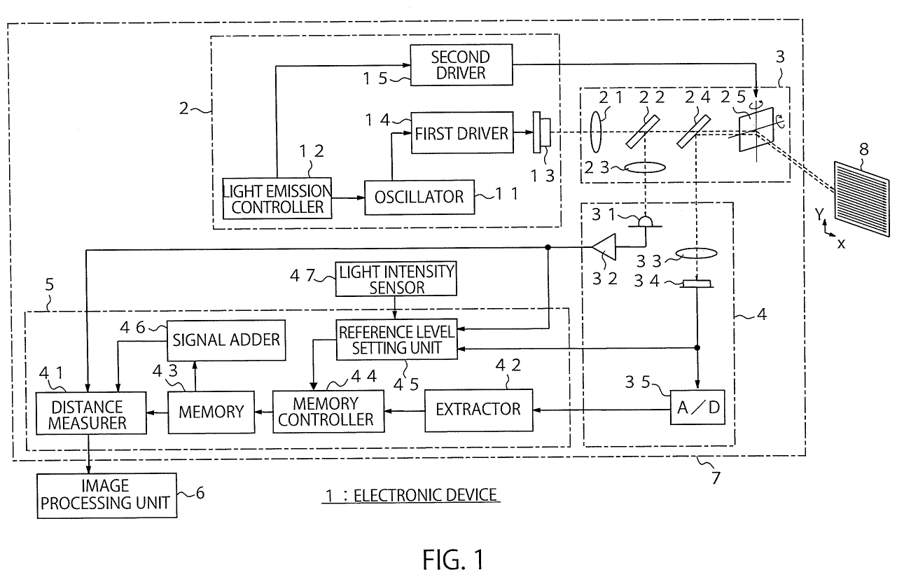

FIG. 1 is a block diagram illustrating a schematic configuration of an electronic apparatus 1 according to a first embodiment. The electronic apparatus 1 shown in FIG. 1 may be mounted on a movable object such as a vehicle. The scope of the movable object includes not only vehicles but also ships, aircrafts, and trains, for example.

The electronic apparatus 1 shown in FIG. 1 includes a light emitter 2, a light controller 3, a light receiver 4, a signal processing unit (processing circuitry) 5, and an image processing unit 6. The light emitter 2, the light controller 3, the light receiver 4, and the signal processing unit 5 constitute a distance measuring device 7. Examples in which the distance measuring device 7 measures a distance by a scanning method and by a time of flight (TOF) method will be described below.

The light emitter 2 emits a first light, which is a laser beam having a predetermined frequency band, for example. A laser beam is coherent light with uniform phase and frequency. The light emitter 2 intermittently emits pulses of the first light at a predetermined cycle. The cycle in which the light emitter 2 emits the first light is longer than the period of time in which the distance measuring device 7 measures a distance based on each pulse of the laser beam.

The light emitter 2 includes an oscillator 11, a light emission controller 12, a light source 13, a first driver 14, and a second driver 15. The oscillator 11 generates an oscillation signal in accordance with the cycle for emitting the first light. The first driver 14 intermittently supplies power to the light source 13 in synchronization with the oscillation signal. The light source 13 intermittently emits the first light using the power from the first driver 14. The light source 13 may be a laser element that emits a single laser beam, or a laser unit that emits a plurality of laser beams at a time. The light emission controller 12 controls the second driver 15 in synchronization with the oscillation signal. The second driver 15 supplies a drive signal in synchronization with the oscillation signal to the light controller 3 in accordance with a command from the light emission controller 12.

The light controller 3 controls the direction of the first light emitted from the light source 13. The light controller 3 also controls the direction of a second light to be received.

The light controller 3 includes a first lens 21, a beam splitter 22, a second lens 23, a half mirror 24, and a scan mirror 25.

The first lens 21 collects the first light emitted from the light emitter 2 and guides the collected first light to the beam splitter 22. The beam splitter 22 splits the first light from the first lens 21 into two directions, and guides the split lights to the second lens 23 and the half mirror 24. The second lens 23 guides one of the split lights (first split light) from the beam splitter 22 to the light receiver 4.

The half mirror 24 transmits the other of the split lights (second split light) from the beam splitter 22 and guides it to the scan mirror 25. The half mirror 24 reflects the second light, which includes reflected light entering the electronic apparatus 1, toward the light receiver 4.

The scan mirror 25 rotates its mirror surface in synchronization with the drive signal from the second driver 15 included in the light emitter 2, using the driving power of the second driver 15. As a result, the direction of the reflection of a second split light (of the first light), which passes through the half mirror 24 and is incident on the mirror surface of the scan mirror 25, is controlled. The first light emitted from the light controller 3 may be sent for scan in at least one direction by rotating the mirror surface of the half mirror 24 at a constant frequency. The first light may be emitted from the light controller 3 in two directions if two axes are provided to rotate the mirror surface. In FIG. 1, the scan mirror 25 sends the first light emitted from the electronic apparatus 1 in an X direction and a Y direction for scan.

If an object 8 such as a human or a solid material is present in a scanning range of the first light emitted from the electronic apparatus 1, the first light is reflected on the object 8. At least part of the reflected light from the object 8 moves along a path that is substantially the same as the path of the first light, and is incident on the scan mirror 25 included in the light controller 3. The mirror surface of the scan mirror 25 is rotated at a constant frequency. However, since the laser beam travels at light speed, the reflected light from the object 8 is incident on the mirror surface while the angle of the mirror surface of the scan mirror 25 is substantially unchanged. After being incident on the mirror surface, the reflected light from the object 8 is reflected on the half mirror 24 and received by the light receiver 4.

The light receiver 4 includes a photodetector 31, an amplifier 32, a third lens 33, a light receiving sensor 34, and an analog-to-digital converter 35. The photodetector 31 receives the first split light (of the first light) from the beam splitter 22 and converts it to an electrical signal. The photodetector 31 detects emission timing at which the first light is emitted. The amplifier 32 amplifies the electrical signal outputted from the photodetector 31.

The third lens 33 focuses the second light reflected on the half mirror 24 to form an image on the light receiving sensor 34. The light receiving sensor 34 receives the second light and converts it to an electrical signal. The light receiving sensor 34 may be a silicon photomultiplier (SiPM), for example. The SiPM is a photo-sensing element including avalanche photodiodes (APD) that are two-dimensionally arranged in an array form. A reverse-bias voltage that is higher than a breakdown voltage of the APDs is applied to operate the SiPM in a region called “Geiger mode.” The gain of the APDs in the Geiger mode is very high. Therefore, a slight light of one photon may be measured. The electrical signal obtained by the photoelectric conversion at the light receiving sensor 34 is further converted to a digital signal at the analog-to-digital converter 35.

The signal processing unit 5 measures a distance to the object 8 that reflects the first light, and stores the digital signal corresponding to the second light in a memory 43. The signal processing unit 5 includes a distance measurer 41, an extractor 42, and the memory 43.

The distance measurer 41 measures the distance to the object 8 based on the first light and the reflected light. The distance measurer 41 also measures the distance to the object 8 using information on the second light received at a first point in time, and information on the second light received at a second point in time stored in the memory 43, the second point in time being earlier than the first point in time. More specifically, if the light intensity of the second light becomes greater than a reference level within a predetermined period of time from the emission timing at which the first light is emitted, the memory 43 does not store the digital signal corresponding to the second light that is received within the predetermined period of time, and the distance measurer 41 measures the distance to the object 8 based on the timing at which the light intensity of the received second light becomes greater than the reference level using the following expression (1).

Distance=Light Speed ×(reflected light reception timing—first light emission timing)/2 (1)

The extractor 42 extracts part of the second light received by the light receiver 4, the part being effectively used in the measurement operation performed by the distance measurer 41. As will be described later, the extractor 42 only extracts light that is needed for measuring the distance in order to reduce the number of digital signals stored in the memory 43.

The memory 43 stores the digital signal that corresponds to the part of light extracted by the extractor 42. Thus, the digital signals stored in the memory 43 do not correspond to the entire second light received by the light receiver 4, but only part of the second light that is effectively used for the distance measurement operation, which is extracted by the extractor 42.

The signal processing unit 5 shown in FIG. 1 may also include a memory controller 44, a reference level setting unit 45, and a signal adder 46 in addition to the distance measurer 41, the extractor 42, and the memory 43 described above.

The memory controller 44 controls the memory 43 as to whether or not to store the digital signal, which is the information on the second light received by the light receiver 4, based on a reference level for the light intensity of the second light. More specifically, if the light intensity of the second light becomes greater than a first reference level within a predetermined period of time from the emission timing at which the first light is emitted, the memory controller 44 does not allow the memory 43 to store the digital signal corresponding to the second light received within the predetermined period of time. If the light intensity of the second light is continuously equal to or less than the first reference level within the predetermined period of time, the memory controller 44 allows the memory 43 to store the digital signal corresponding to the second light received within the predetermined period of time. Thus, if a reflected light that travels a short distance is received, i.e., if the received light is a reflected light from an object 8 that is present near the electronic apparatus 1, the memory controller 44 does not allow the memory 43 to store a digital signal corresponding to the reflected light. In this case, the distance measurer 41 measures the distance using the reflected light from the near object. If the light intensity of the second light becomes greater than the reference level at least once, the memory controller 44 causes the memory 43 to store the number of times the intensity of the second light becomes greater.

The reference level setting unit 45 sets the first reference level, the value of which changes as the time elapses from the emission timing at which the first light is emitted. More specifically, the reference level setting unit 45 lowers the first reference level as the time passes from the emission timing. The reason for this is that as the time passes from the emission timing, the ratio of the reflected light from a more distant object 8 increases in the received light, and as the distance to the object 8 increases, the attenuation of the reflected light becomes greater.

The reference level setting unit 45 may set the first reference level not only based on the time passing from the emission timing at which the first light is emitted but also based on the brightness around the light receiver 4. In this case, the electronic apparatus 1 shown in FIG. 1 may include, for example, a light intensity sensor (brightness detector) 47. The light intensity sensor 47 detects the light intensity around the electronic apparatus 1. The brightness around the light receiver 4 may be obtained from the light intensity detected by the light intensity sensor 47. The reference level setting unit 45 therefore may set the first reference level based on the elapsed time from the emission timing at which the first light is emitted and the brightness around the light receiver 4. For example, as the brightness around the electronic apparatus 1 increases, the influence of the ambient light such as sunlight increases. In such a case, the first reference level is preferably increased. More specifically, the first reference level set by the reference level setting unit 45 is higher in a sunny day than in a cloudy day, and higher in the daytime than in the nighttime.

The memory controller 44 controls the memory 43 as to whether or not to store the digital signal corresponding to the second light received within the predetermined period of time according to the first reference level set by the reference level setting unit 45. More specifically, if the light intensity of the second light becomes greater than the first reference level within the predetermined period of time from the emission timing at which the first light is emitted, the memory controller 44 does not allow the memory 43 to store a digital signal corresponding to the second light received within the predetermined period of time, and if the light intensity of the second light is continuously equal to or less than the first reference level within the predetermined period of time, the memory controller 44 allows the memory 43 to store the digital signal corresponding to the second light received within the predetermined period of time. The state where the light intensity of the second light is greater than the first reference level indicates that the reflected light from a near object 8 is received. In this case, the memory 43 does not store the digital signal since the light intensity of the reflected light is sufficiently high and therefore the reflected light is not covered by noise such as sunlight. In actual cases, the memory controller 44 causes the memory 43 to store the reception timing at which the light intensity of the second light becomes greater than the reference level within the predetermined period of time from the emission timing.

The signal adder 46 performs a signal adding process every time a distance measurement operation is performed on the first light emitted from the light emitter 2. More specifically, if the light controller 3 scan the object 8 with the first light one dimensionally or two dimensionally, the signal adder 46 may obtain a cumulative sum of digital signals for a plurality of adjacent pixels stored in the memory 43 in accordance with the scan result of the first light, thereby improving the noise immunity of the signal. The noise immunity may further be improved by using data acquired during a previous scanning operation when obtaining the cumulative sum. The data that may be used in obtaining a cumulative sum to improve the performance of the measured data will be called “supplemental data.” If the memory 43 has supplemental data when the operation for obtaining a cumulative sum is performed, the supplemental data is used, and if not, the operation for obtaining a cumulative sum is performed without using supplemental data.

When the light intensity of the second light becomes greater than the first reference level within the predetermined period of time, the distance measurer 41 measures the distance to the object 8 based on the point in time (reception timing) at which the light intensity becomes greater than the first reference level. If the light intensity of the second light is continuously equal to or less than the first reference level, the distance measurer 41 measures the distance based on the result of the cumulative sum of the digital signals performed by the signal adder 46. The distance measurer 41 also measures the distance based on the result of the cumulative sum of the digital signals performed by the signal adder 46 when the predetermined period of time passes from the emission timing at which the first light is emitted.

The signal processing unit 5 also includes a small-capacity buffer for temporarily storing digital signals, which is not shown, in addition to the memory 43. The digital signal converted by the analog-to-digital converter 35 is temporarily stored in the buffer. After it is determined which of the digital signals in the buffer are stored in the memory 43, the determined digital signals are stored in the memory 43.

The image processing unit 6 shown in FIG. 1 generates distance image data by imaging the object 8 that is present around the electronic apparatus 1 based on the distance measured by the distance measurer 41. The distance image data generated by the image processing unit 6 is displayed in, for example, a display unit, which is not shown.

As described above, the light receiver 4 receives a reception light including a reflected pulse provided by a reflection of an emitted pulse on an object. The reception light is received during at least a first time and a second time, and the second time is earlier than the first time, a memory configured to store a digital signal representing a part of information on the reception light received during the second time. The signal processing unit 5 measures a distance to the object based on a difference between emission timing of the emitted pulse and reception timing of the reflected pulse by using the information on the reception light received during the first time and the part of information on the reception light received during the second time.

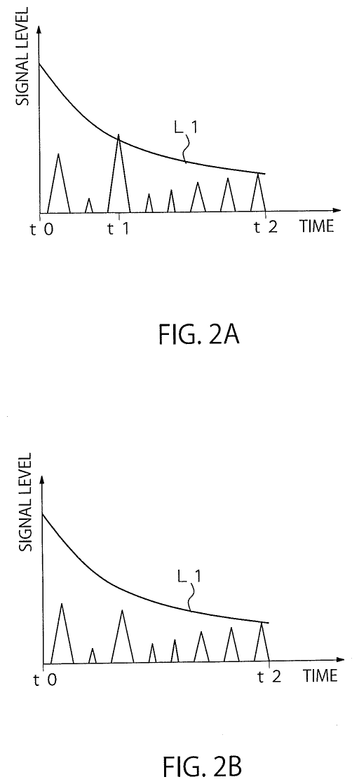

FIGS. 2A and 2B show an example of the first reference level L1 set by the reference level setting unit 45. In each of FIGS. 2A and 2B, the horizontal axis indicates the time, and the vertical axis indicates the light intensity of the second light.

FIGS. 2A and 2B show the change of the first reference level L1 from time t0 at which the light emitter 2 emits the first light to time t2 at which a predetermined period of time passes. In the example of FIGS. 2A and 2B, the reference level setting unit 45 monotonously lowers the first reference level L1 as the time passes. FIG. 2A shows a case where the light intensity of the second light temporarily becomes greater than the first reference level L1 at time t1, which is between time t0 and time t2, and FIG. 2B shows a case where the light intensity of the second light is always equal to or less than the first reference level L1 during the period between time t0 and time t2.

The comparison between the digital signal and the reference level in FIGS. 2A and 2B is performed by using the digital signals temporarily stored in the aforementioned buffer. In the case of FIG. 2A, the light intensity of the received second light is greater than the first reference level L1 at time t1 between time t0 and time t2. In this case, the memory controller 44 does not cause the memory 43 to store the digital signals corresponding to the second light received between time t0 and time t2 in order to reduce the storage capacity of the memory 43.

In the case of FIG. 2B, the light intensity of the received second light is not greater than the first reference level L1 between time t0 and time t2. Therefore, the memory controller 44 causes the memory 43 to store the digital signals corresponding to the second light received between time t0 and time t2. The signal adder 46 obtains a cumulative sum of the digital signals with respect to a plurality of adjacent pixels in the period of time between time t0 and t2. The distance measurer 41 determines whether the reflected light that is reflected on the object 8 is included in the second light during the period between time t0 and time t2 based on the result of the cumulative sum of the digital signals obtained by the signal adder 46.

FIGS. 2A and 2B only show the second light received between time t0 and time t2. The second light received after time t2 may also be used in the cumulative sum operation at the signal adder 46 in principle. The reason for this is that the reflected light received after time t2 corresponds to the reflected light from the object 8 that is located at a distance, and therefore is not likely to have a high light intensity.

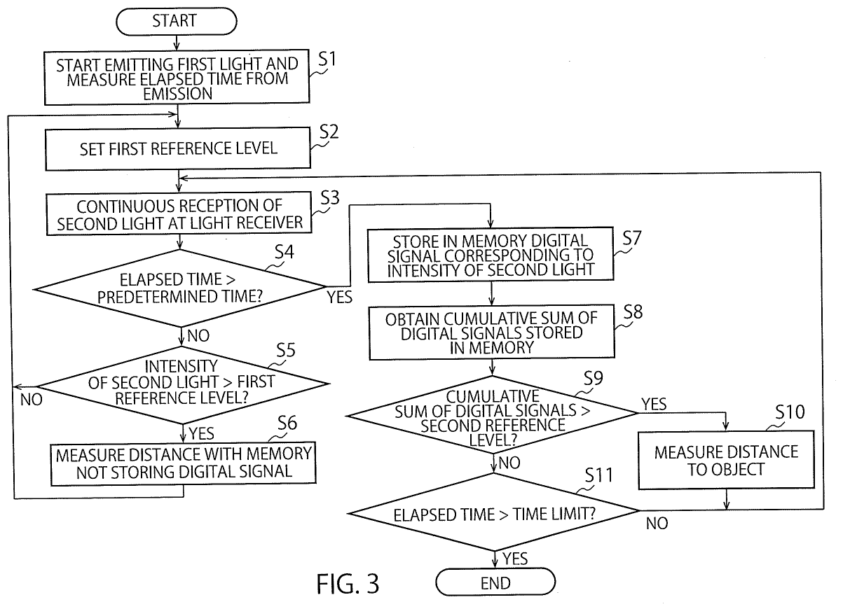

FIG. 3 is a flowchart showing the process of operation performed by the electronic apparatus 1 according to the first embodiment. Before starting this flowchart, the reference level setting unit 45 may generate a table of the first reference level L1 as shown in FIGS. 2A and 2B in advance, or may create the first reference level L1 in real time.

At the same time as the emission of the first light from the light emitter 2, the measurement of the elapsed time from the emission timing starts (step S1). Then, the first reference level L1 is set at the reference level setting unit 45 in consideration of the elapsed time, and if necessary, the brightness around the light receiver 4 (step S2).

The second light is continuously received at the light receiver 4 after the emission of the first light at step S1 (step S3). It is then determined whether the time passing from the emission of the first light at step S1 reaches a predetermined time (step S4). For example, the predetermined time may be set in consideration of a case where the object 8 is located at a distance of several tens of meters from the light receiver 4. The specific value of the predetermined time may be arbitrarily set.

If it is determined that the elapsed time does not reach the predetermined time at step S4, whether the light intensity of the second light received at the light receiver 4 is greater than the first reference level L1 is determined (step S5). If the light intensity is determined to be greater than the first reference level L1, the second light received at that light reception timing is determined to be an effective reflected light from the object 8, and the distance to the object 8 is measured at the distance measurer 41 based on the light reception timing (step S6). In such a case, the memory controller 44 controls the memory 43 not to store the digital signal corresponding to the second light received at the light receiver 4. Steps S4 and S5 are performed by the extractor 42. After step S6, the process after step S2 is repeated. The process after step S2 is also repeated when the light intensity of the second light is determined to be equal to or less than the first reference level L1 at step S5.

If it is determined that the elapsed time passes the predetermined time at step S4, the memory 43 stores the digital signal corresponding to the light intensity of the second light (step S7). The signal adder 46 then obtains a cumulative sum of the digital signals stored in the memory 43 (step S8).

It is then determined whether the result of the cumulative sum of the digital signals is greater than a second reference level (step S9). The value of the second reference level may be changed depending on the elapsed time from the emission timing or the brightness of the surrounding areas as in the case of the first reference level L1.

If it is determined at step S9 that the result of the cumulative sum of the digital signals is greater than the second reference level, the distance measurer 41 measures the distance to the object 8 based on the light reception timing at that instant and the light emission timing (step S10).

If it is determined at step S9 that the result of the cumulative sum of the digital signals is not greater than the second reference level, whether the elapsed time from the emission of the first light reaches a time limit is determined (step S11). If the time limit is not reached, the process after step S3 is repeated. If the time limit is reached, the process shown in FIG. 3 is ended.

As described above, in the first embodiment, part of the second light received at the light receiver 4, which is effectively used for the distance measurement, is extracted, and a digital signal corresponding to the part is stored in the memory 43. This may lead to a reduction in storage capacity of the memory 43. More specifically, the reflected light from the object 8 that is present near the electronic apparatus 1 has a greater light intensity than ambient light such as sunlight. Therefore, the digital signal corresponding to the reflected light is not stored in the memory 43 when the distance measurement is performed. The storage capacity of the memory 43 may be reduced since digital signals are not stored in the memory 43 in the case where it is not necessary to store them.

It is considered to be difficult to distinguish between ambient light and a reflected light from the object 8 that is present at a distance from the electronic apparatus 1. In order to distinguish the reflected light from the ambient light easily, digital signals corresponding to the reflected light are stored in the memory 43 and a cumulative sum of the digital signals are obtained at the signal adder 46. In this embodiment, the first reference level L1 and the second reference level are changed depending on the elapsed time from the emission timing in consideration of the fact that as the reflected light travels for a longer period of time, the light intensity of the reflected light attenuates more. Furthermore, the first reference level L1 and the second reference level are changed also in consideration of the light intensity of ambient light such as sunlight. As a result, the reflected light included in the second light may be appropriately extracted in consideration of the brightness of the surrounding areas.

### Second Embodiment

If a silicon photomultiplier (SiPM) is used as the light receiving sensor 34 of the light receiver 4, it may detect faint light. However, because of a characteristic of the SiPM, in which the gradient of the falling edge of a reception signal is more gradual than the rising edge, it takes a long time for the reception signal to become zero. Therefore, if digital signals that are obtained as a result of an accurate sampling of signals received by the SiPM are stored in the memory 43, the storage capacity of the memory 43 may need to be increased.

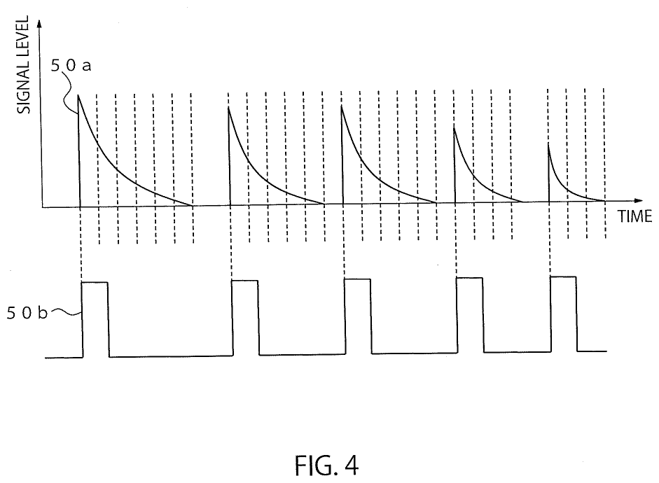

FIG. 4 is a schematic diagram showing the signal waveform of signals received by the SiPM. In FIG. 4, the horizontal axis indicates the time, and the vertical axis indicates the reception signal level. The broken lines in FIG. 4 indicate the sampling frequency of the analog-to-digital converter 35. Since the reception signal of the SiPM rises steeply and reduces to zero with a long trail, the number of samples at the analog-to-digital converter 35 increases, leading to an increase in data volume of digital signals.

In order to solve this problem, digital signals obtained by shaping the waveform of signals received by the SiPM are stored in the memory 43 in the second embodiment in order to reduce the storage capacity.

The electronic apparatus 1 according to the second embodiment has the same block configuration as the electronic apparatus 1 shown in FIG. 1, but the operation of the extractor 42 is different from that in the first embodiment.

The extractor 42 according to the second embodiment extracts the timing at which the light intensity of the intermittent light 50a included in the second light received by the light receiver 4 becomes greater than a predetermined reference level. Each intermittent light 50a has a single waveform that rises from the reference level and falls thereafter as shown in FIG. 4. In the example shown in FIG. 4, five intermittent lights 50a are received.

More specifically, the extractor 42 converts each intermittent light 50a to a pulse signal 50b in synchronization with the rising edge of the intermittent light 50a as shown in the lower part of FIG. 4, the pulse signal 50b having a constant light intensity and a rectangular waveform that is narrower than the time width of the intermittent light 50a.

The waveform of the intermittent light 50a in the upper part of FIG. 4 is that of a digital signal obtained by analog-to-digital conversion performed by the analog-to-digital converter 35. As described above, the operation of the extractor 42 is performed after the signal received by the SiPM is converted to a digital signal at the analog-to-digital converter 35. However, if necessary, the analog signal may be converted to a pulse signal before being converted to a digital signal at the analog-to-digital converter 35, and then converted to a digital signal at the analog-to-digital converter 35.

By narrowing the pulse width of the pulse signal 50b as shown in FIG. 4, the data volume of the reception signals stored in the memory 43 may be reduced.

Since the timing at which the reception signal rises may be specified by the timing at which the digital signal generated by the analog-to-digital converter 35 rises, and the peak value at the rising of the reception signal may be specified from the value of the digital signal, the waveform having a long trail at the falling edge outputted by the light receiving sensor 34 may be reliably reproduced later. The reason for this is that the waveform at the falling edge of a signal of the SiPM may be accurately estimated from a simulation based on the characteristics of the SiPM. Therefore, if the reception signal at the light receiver 4 is converted to the pulse signal 50b having a rectangular shape at the extractor 42, the original shape of the reception signal can be reproduced. Accordingly, there is no practical problem.

As described above, in the second embodiment, the second light received at the light receiver 4 is converted to the pulse signal 50b having a rectangular waveform with a narrow pulse width and then stored in the memory 43. As a result, the number of digital signals stored in the memory 43 may be reduced.

The process performed by the extractor 42 according to the second embodiment may be applied to the first embodiment. Therefore, the extractor 42 according to the first embodiment may convert each intermittent light 50a included in the second light received by the light receiver 4 to a pulse signal 50b having a rectangular waveform, and then compares the level of the pulse signal 50b with the first reference level, like the extractor 42 according to the second embodiment. This may further reduce the storage capacity of the memory 43 according to the first embodiment.

### Third Embodiment

In a third embodiment, whether the reflected light is included in the second light is determined from a result of the cumulative sum of the second light received by the light receiver 4 in each of a plurality of reception time regions.

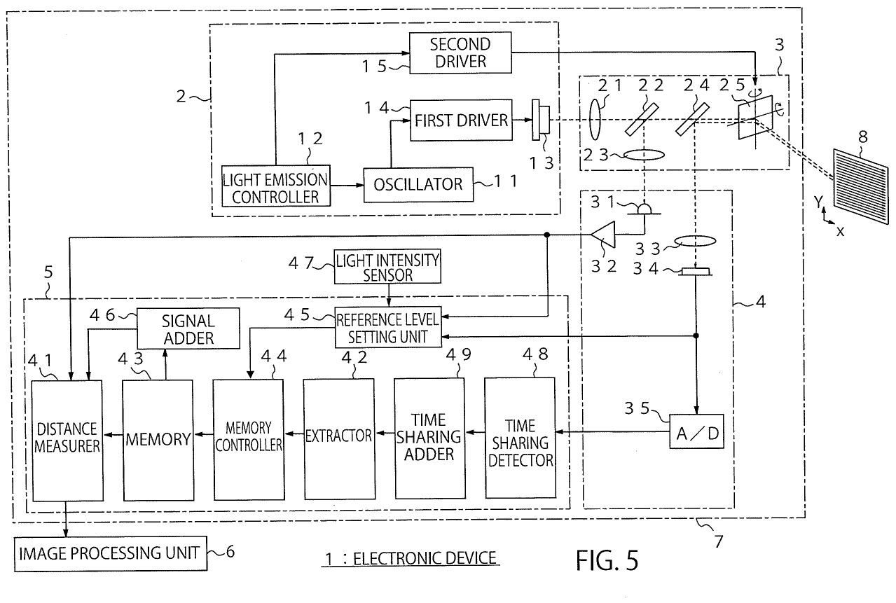

FIG. 5 is a block diagram showing a schematic configuration of an electronic apparatus 1 according to the third embodiment. In addition of the configuration shown in FIG. 1, the electronic apparatus 1 shown in FIG. 5 has a time sharing detector 48 and a time sharing adder 49. In addition to the memory 43, the signal processing unit 5 of the electronic apparatus 1 shown in FIG. 5 has a buffer (not shown) that temporarily stores a digital signal converted at the analog-to-digital converter 35, like the second embodiment. The digital signal temporarily stored in the buffer is then inputted to the time sharing detector 48.

The time sharing detector 48 detects the light intensity of second light 50c received by the light receiver 4 in each reception time region. The time sharing adder 49 obtains a cumulative sum of the light intensity of the second light 50c in each reception time region. More specifically, the time sharing detector 48 detects a digital signal corresponding to the second light 50c in each reception time region. The time sharing adder 49 obtains a cumulative sum of the digital signal corresponding to the second light 50c in each reception time region.

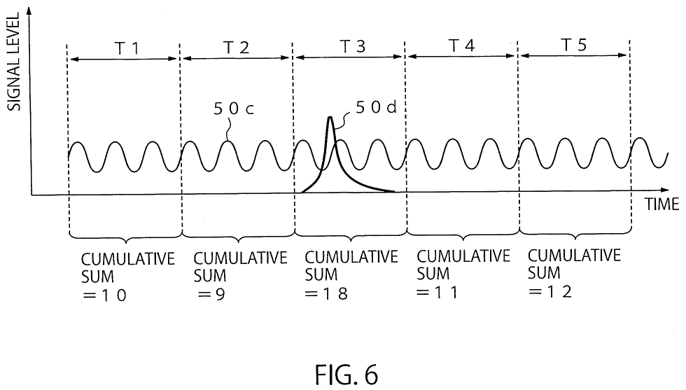

FIG. 6 is a diagram schematically showing the operations of the time sharing detector 48 and the time sharing adder 49. In the example of FIG. 6, a cumulative sum of digital signals corresponding to the second light 50c in each of five time regions T1 to T5 is obtained. The obtained value in the time region T3 in FIG. 6 is at a maximum value, 18, since a reflected wave 50d is present in addition to the waves of the second light 50c. The values of the time regions T1 and T3 to T5 are 10, 9, 11, and 12, respectively.

The memory controller 44 compares the values of the respective time regions, determines that the reflected wave 50d may be received during the time region T3 that has the maximum value, and stores a digital signal corresponding to the second light 50c in time region T3 in the memory 43. In this case, the digital signal of the time region T3 stored in the buffer is stored in the memory 43. The memory controller 44 does not allow the memory 43 to store digital signals corresponding to the second light 50c in time regions T1 and T3 to T5. This prevents an increase in storage capacity of the memory 43. As described above, in the third embodiment, a cumulative sum of digital signals corresponding to the second light 50c received by the light receiver 4 in each of a plurality of reception time regions is obtained, the obtained values of the respective reception time regions are compared to one another, and only the data of the reception time region having the maximum value is stored in the memory 43. As a result, only the data of a reception time region that is highly likely to have the reflected wave 50d sent from the object 8 is stored in the memory 43. This may reduce the storage capacity of the memory 43.

At least part of the functions and the operations of the electronic apparatus 1 in each of the above-described embodiments may be realized by means of hardware or software. If software is used, a program relating to the functions and the operations is stored in a storage device, and read and executed by a processor. The storage device for storing the program may be a fixed type storage device such as a hard disk drive (HDD) or a semiconductor memory such as a random access memory (RAM) or a read only memory (ROM).

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An electronic apparatus comprising:
a light receiver configured to receive a reception light including a reflected pulse provided by a reflection of an emitted pulse on an object, wherein the reception light is received during at least a first time and a second time, and the second time is earlier than the first time;
a memory configured to store a digital signal representing a part of information on the reception light received during the second time; and
processing circuitry configured to measure a distance to the object based on a difference between emission timing of the emitted pulse and reception timing of the reflected pulse by using the information on the reception light received during the first time and the part of information on the reception light received during the second time.

2. The electronic apparatus according to claim 1, further comprising a memory controller configured to control the memory as to whether or not to store the digital signal corresponding to the part of the information on the reception light received by the light receiver in the memory, based on a reference level of light intensity of the reception light.

3. The electronic apparatus according to claim 2, wherein the memory controller controls the memory not to store the digital signal corresponding to the reception light received within a predetermined period of time from the emission timing at which the emitted pulse is emitted if the light intensity of the reception light becomes greater than the reference level within the predetermined period of time.

4. The electronic apparatus according to claim 2, wherein the memory controller controls the memory to store the digital signal corresponding to the reception light received within a predetermined period of time from the emission timing at which the emitted pulse is emitted if the light intensity of the reception light is continuously equal to or less than the reference level within the predetermined period of time.

5. The electronic apparatus according to claim 2, wherein the memory controller controls the memory to store the reception timing at least once, at which the light intensity of the reception light becomes greater than the reference level.

6. The electronic apparatus according to claim 2, further comprising a signal adder configured to obtain a cumulative sum of digital signals stored in the memory,
wherein the processing circuitry measures the distance, based on the reception timing when the light intensity of the reception light becomes greater than the reference level within a predetermined period of time from the emission timing at which the emitted pulse is emitted, or based on the cumulative sum of the digital signals obtained by the signal adder when the light intensity of the reception light is continuously equal to or less than the reference level within the predetermined period of time.

7. The electronic apparatus according to claim 6, wherein the processing circuitry measures the distance based on the cumulative sum of the digital signals obtained by the signal adder after the predetermined period of time passes from the emission timing at which the emitted pulse is emitted.

8. The electronic apparatus according to claim 2, further comprising a reference level setting unit configured to set the reference level that changes in value in accordance with elapsed time from the emission timing at which the emitted pulse is emitted,
wherein the memory controller determines whether or not to control the memory to store the digital signal corresponding to the reception light received within a predetermined period of time from the emission timing at which the emitted pulse is emitted based on the reference level set by the reference level setting unit.

9. The electronic apparatus according to claim 8, further comprising a brightness detector configured to detect brightness of a surrounding area of the light receiver,
wherein the reference level setting unit sets the reference level based on the brightness detected by the brightness detector and the elapsed time.

10. The electronic apparatus according to claim 1, further comprising an extractor configured to extract generation timing at which an intermittent light is generated every time the light intensity of the reception light received by the light receiver becomes greater than a predetermined reference level,
wherein the memory stores a digital signal corresponding to the light intensity of the intermittent light at the generation timing, and
wherein the processing circuitry measures the distance based on the generation timing corresponding to the digital signal stored in the memory and the emission timing at which the emitted pulse is emitted.

11. The electronic apparatus according to claim 10,
wherein the intermittent light has a waveform in which a rising edge is steeper than a falling edge, and
wherein the extractor extracts timing of the rising edge of the intermittent light.

12. The electronic apparatus according to claim 10,
wherein the extractor converts the intermittent light to a pulse signal, which has a rectangular waveform narrower than a time width of the intermittent light and has constant light intensity, and
wherein the memory stores the digital signal in accordance with a signal level of the pulse signal.

13. The electronic apparatus according to claim 1, further comprising:
a time sharing detector configured to divide the reception light received by the light receiver into a plurality of sections corresponding to a plurality of reception time regions, and detect the light intensity of the reception light in each reception time region; and
a time sharing adder configured to obtain a cumulative sum of the light intensity of the reception light for each of the plurality of reception time regions,
wherein the memory stores the digital signal corresponding to one of the reception time regions having a maximum cumulative sum of the light intensity of the reception light, and
wherein the processing circuitry measures the distance based on the digital signal stored in the memory and the emission timing at which the emitted pulse is emitted.

14. The electronic apparatus according to claim 1, further comprising a light emitter configured to emit the emitted pulse,
wherein the processing circuitry obtains the emission timing of the emitted pulse.

15. A distance measuring method comprising:
receiving a reception light including a reflected pulse provided by a reflection of an emitted pulse on an object, wherein the reception light is received during at least a first time and a second time, and the second time is earlier than the first time;
storing, in a memory, a digital signal representing a part of information on the reception light received during the second time; and
measuring a distance to the object based on a difference between emission timing of the emitted pulse and reception timing of the reflected pulse by using the information on the reception light received during the first time and the part of information on the reception light received during the second time.

16. The distance measuring method according to claim 15, further comprising controlling the memory as to whether or not to store the digital signal corresponding to the part of the information on the reception light received by the light receiver in the memory, based on a reference level of light intensity of the reception light.

17. The distance measuring method according to claim 16, wherein the controlling controls the memory not to store the digital signal corresponding to the reception light received within a predetermined period of time from the emission timing at which the emitted pulse is emitted if the light intensity of the reception light becomes greater than the reference level within the predetermined period of time.

18. The distance measuring method according to claim 16, wherein the controlling controls the memory to store the digital signal corresponding to the reception light received within a predetermined period of time from the emission timing at which the emitted pulse is emitted if the light intensity of the reception light is continuously equal to or less than the reference level within the predetermined period of time.

19. The distance measuring method according to claim 16, wherein the controlling controls the memory to store the reception timing at least once, at which the light intensity of the reception light becomes greater than the reference level.

20. The distance measuring method according to claim 16, further comprising obtaining a cumulative sum of digital signals stored in the memory,
wherein the measuring measures the distance, based on the reception timing when the light intensity of the reception light becomes greater than the reference level within a predetermined period of time from the emission timing at which the emitted pulse is emitted, or based on the cumulative sum of the digital signals obtained by the signal adder when the light intensity of the reception light is continuously equal to or less than the reference level within the predetermined period of time.
